(19) United States
(12) Patent Application Publication
(10) Pub. No.: US 2004/0068846 A1
(43) Pub. Date: Apr. 15, 2004

(54) Ring part comprising at least two partial rings and method for joining the partial rings to form a closed ring part

(76) Inventor: Stefan Karlinger, Augsburg (DE)

Correspondence Address: MCGLEW & TUTTLE, PC, 1 SCARBOROUGH STATION PLAZA, SCARBOROUGH, NY, 10510-0827, US

(21) Appl. No.: 10/664,702

(22) Filed: Sep. 18, 2003

(30) Foreign Application Priority Data
Sep. 21, 2002 (DE) 102 44 029.8

(51) Int. Cl. F16L 33/02

(52) U.S. Cl. 24/20 EE

(57) ABSTRACT

In order to form a stable, radial force-absorbing ring part (1) from at least two partial rings (2, 2′), the invention provides such a ring part (1) with at least two partial rings (2, 2′) to be joined together with joining devices on the front faces thereof, in which the joining devices are non-flexible, positively interlocking shapes (3, 4). For joining the partial rings (2, 2′) and for creating the ring part (1), the partial rings (2, 2′) are joined together by axial sliding of their joining devices constructed as interlocking shapes (3, 4) into each other.

### FIELD OF THE INVENTION

The invention relates to a ring part with at least two partial rings to be joined together with joining devices at the front faces of the partial rings as well as a method for closing a ring part, comprising at least two partial rings to be joined together with joining devices on the front faces of the partial rings.

### BACKGROUND OF THE INVENTION

In conjunction with protective hoses for supply lines on machines or robots, use is frequently made of closed, circular cylindrical parts, either as end pieces mounted on the ends of the ribbed protective hose, or as guide holders for such a hose or supply line, or as protective or wearing rings. These closed ring parts often have a complex structure. They can be directly joined together by means of screws, which is complicated and generally leads to the fact that half-shells of these functional parts cannot be produced in a single mould and instead different moulds are required for this purpose. Therefore, frequently such circular symmetrical functional parts are held together by partial rings, either by a closed ring or by a split ring.

It is not possible to reequip closed rings if they are destroyed. Split rings have on the front faces of their partial rings joining devices, which are generally constructed as flexible hooks, so that the two partial rings can be hooked onto one another by a radial movement for forming the closed ring part, the elastic joining devices hooking behind one another during the closing process by means of elastic hooks with undercuts. However, the holding power of such elastic joining means is often inadequate, so that such a closed ring can fall apart again. To the extent that other joining mechanisms are used, this leads to generally large structures which do not have a small, circular outer contour, as is desirable or even necessary for the indicated uses.

Therefore the problem of the invention is to provide a ring part comprising several individual parts, which is compact, has circular inner and outer contours with a very limited thickness, but which still permits a reliably secure and stable closed connection of the partial rings.

### SUMMARY OF THE INVENTION

According to the invention the set problem is solved by a ring part of the aforementioned type, which is characterized in that the joining devices are non-flexible, positively interlocking shapes.

According to the method of the invention for joining together the partial rings to form a closed ring part, the partial rings are joined together by axially sliding their joining devices which are constructed as interlocking shapes, into each other.

The joining together of the partial rings to form a ring part more particularly takes place in a radial and circumferentially positive manner. The shapes are not flexible, being instead rigid and therefore very stable, so that it is virtually impossible for an unintentional release to take place, even under the action of forces, so that a stable ring part is obtained.

According to an extremely preferred development, the shapes have interlocking hooks. The individual partial rings are identically constructed and according to a preferred development the shapes are constructed in a substantially point symmetrical manner.

According to another preferred development back-engaging faces of the shapes are oriented in inclined manner to the radius of the ring part and in particular the faces, which are inclined to the radius, pass from an inner, concave edge, in the vicinity of which the hook is joined to the partial ring, to an outer, free, concave edge on the actual partial ring.

It is also advantageous if the shapes of the partial rings rub on one another in the axial direction and are held in the closed position by a certain frictional force.

### BRIEF DESCRIPTION OF THE DRAWINGS

Further advantages and features of the invention can be gathered from the following description of an embodiment of the invention with reference to the attached drawings, wherein show:

FIG. 1 A preferred development of a closed closing ring according to the invention in side view.

FIG. 2 A half-ring of an inventive closing ring in side view.

FIGS. 3a to 3c Method steps in closing a closing ring according to the invention.

FIGS. 4a and 4b A functional part comprising two half-shells, without the closing ring (FIG. 4a) and with engaged, closed closing ring (FIG. 4b).

### DETAILED DESCRIPTION OF THE DRAWINGS

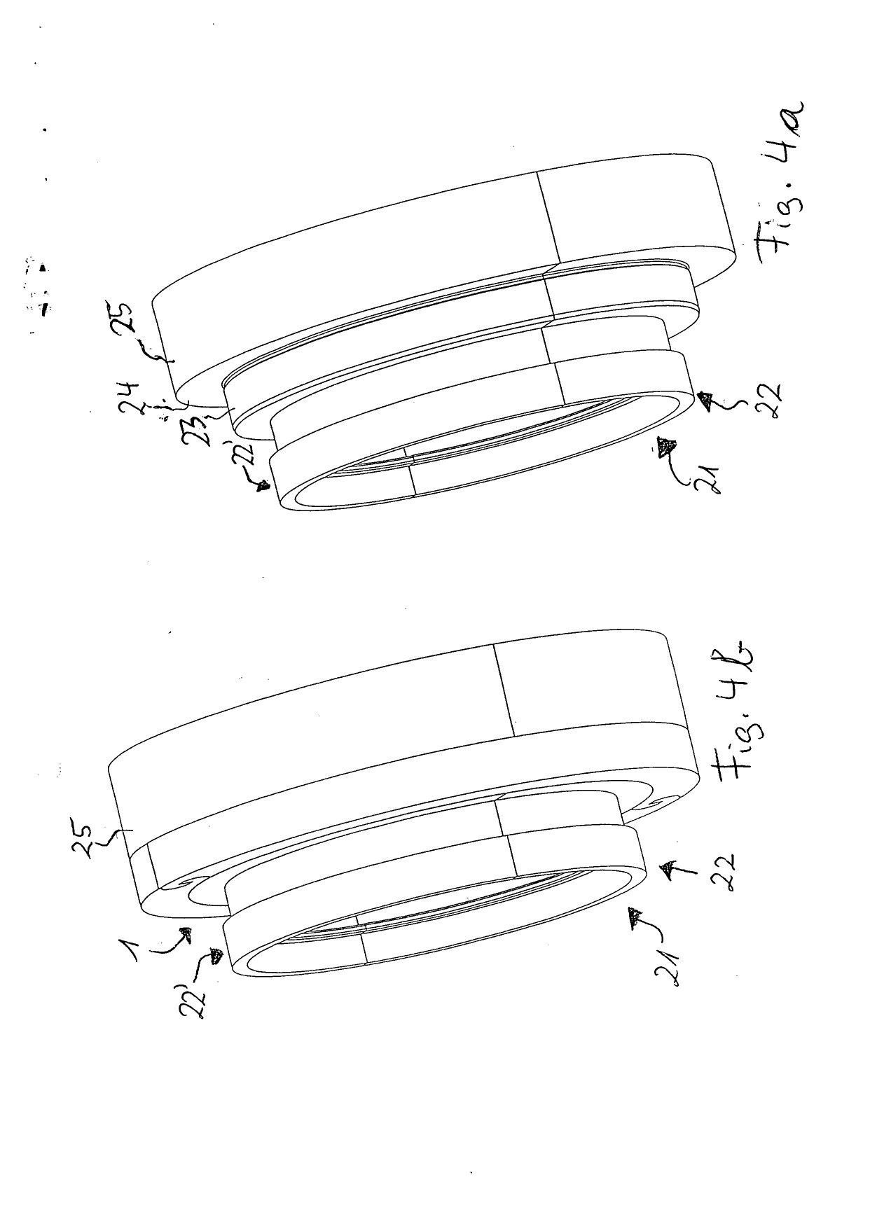

A ring 1 according to the invention is generally used as a closing or retaining ring in order to radially hold together functional parts comprising several partial rings and elements, such as end pieces located on a ribbed hose surrounding a supply line, optionally in an articulated or trumpet construction, as well as trumpet-like or biconical guide elements for such a hose. An end piece for such a ribbed hose is shown in a simple form in FIGS. 4a and 4b.

In the preferred development shown the closing ring 1 comprises two partial closing rings 2, 2′. The partial rings 2, 2′ are identically constructed and have on their front faces in each case complimentary form-fit shapes 3, 4. In the closed state of ring 1, in each case one form-fit shape 3 of one partial ring 2 engages positively with a form-fit shape 4 of the other partial ring 2′ and vice versa.

The interlocking form-fit shapes 3, 4 are also constructed in substantially point or rotationally symmetrical manner (in the case of rotations of around 180øC).

The form-fit shape 3 has a web 5 extending into the inner area of the partial ring 2 or 2′ and on its free end an undercut hook 6. Opposite to the inner or turned back, free edge 7 of hook 6 the front face of partial ring 2, 2′ has a concave, arcuate, end wall 8. A recess 9 is formed between hook 6 and wall 8.

The inner, undercut wall 11 of hook 6 is not directed radially, but is instead inclined thereto in such a way that the wall 11 passes from the concave transition edge 12 of web 5 to the convex, free edge 7 inclined to the radial and running back to the arcuate wall 8.

With respect to an outer web 5′ constructed in the vicinity of the outer wall of partial ring 2, 2′ the hook 6′, its free, rearwardly directed edge 7′, the concave, arcuate wall 8′, the recess 9′ formed between hook 6′ and wall 8′, the inner wall 11′ and the inner, concave edge 12′ in the transition area between wall 11′ and web 5′, the shape 4 is constructed in complimentary manner to shape 3.

The contour of hook 6 precisely corresponds to the contour of recess 9′ and the contour of hook 6′ precisely corresponds to recess 9, so that the hook in each case fits into the corresponding recess, whilst ensuring frictional contact.

With respect to the centre point of the connecting line of edges 7-12 and 7′-12′ on surface 8 or 8′, they are constructed in substantially point symmetrical (or rotationally symmetrical about 180ø) and in the drawing the point is designated P. In the closed state points P, P′ coincide. All the shapes 3, 4 are essentially rigid and non-flexible, so that a radial hooking behind of the shape is impossible.

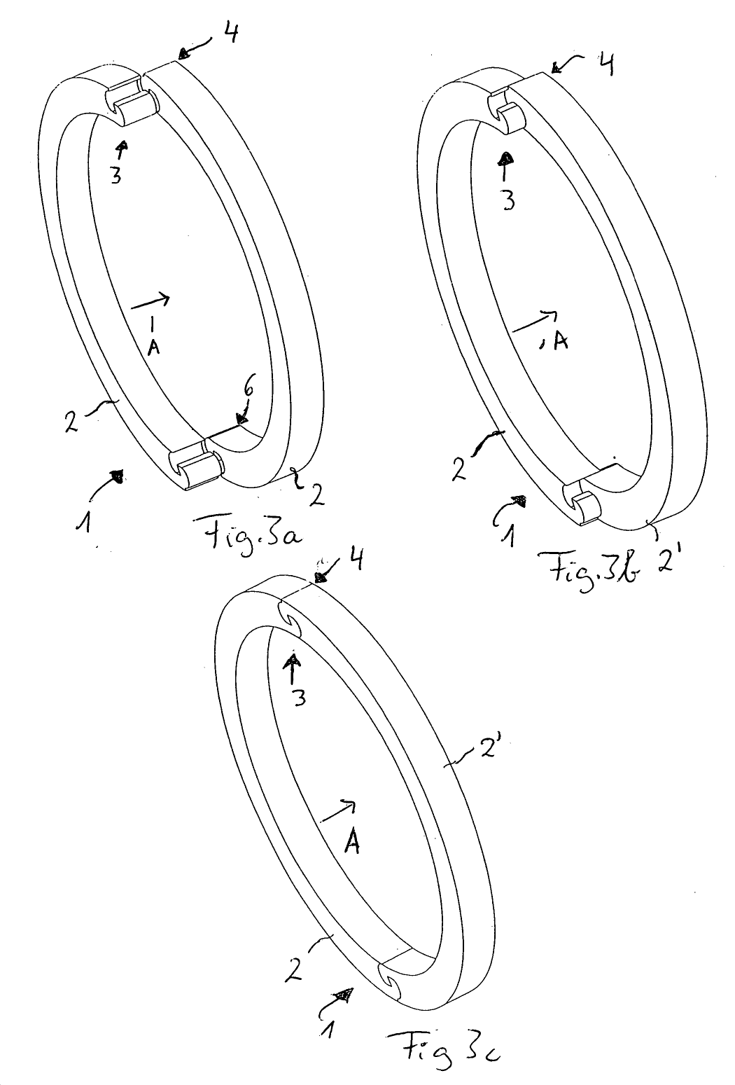

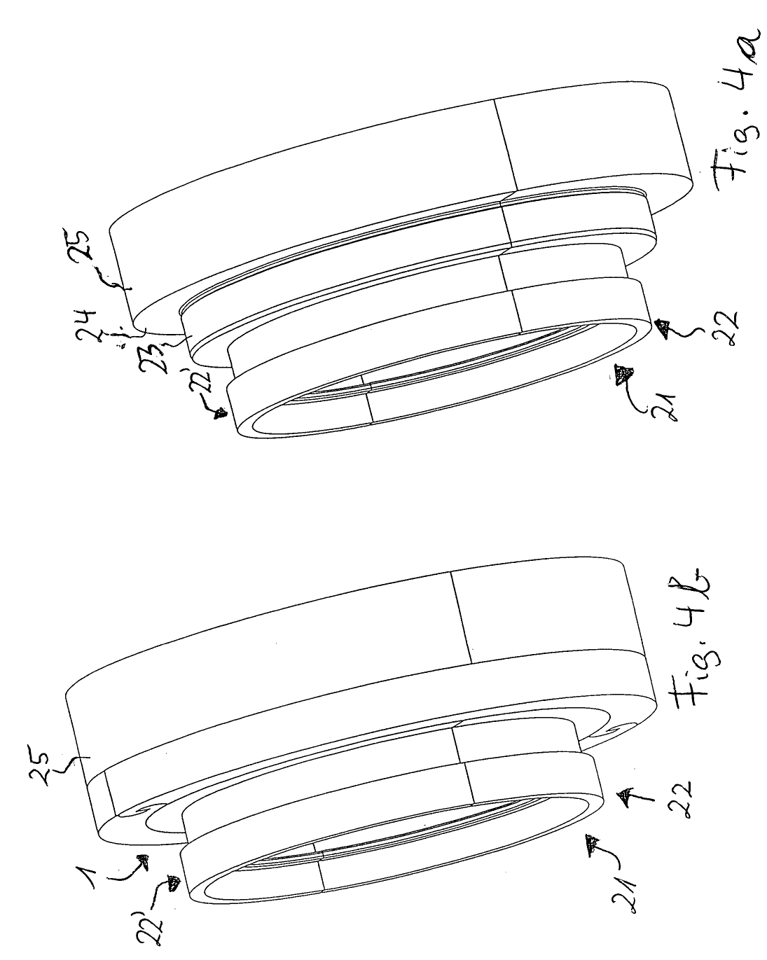

The closing of ring 1 by joining the partial rings 2, 2′ takes place in the manner shown in FIGS. 3a to 3c, in that the partial rings 2, 2′ are laterally engaged in complimentary shapes, so that the hook 6 of the first partial ring 2 is located in the recess 9′ of the other partial ring 2′ and the hook 6′ of the other partial ring 2′ is positioned alongside the recess 9 of ring part 2 and vice versa. Subsequently and as illustrated in the sequence of drawings 3a to 3c, the partial rings 2, 2′ are axially slid into each other in the direction of arrow A until the closing position of FIG. 3c is reached.

As stated, the closing ring 1 according to the invention is e.g. used for radially holding together a more complex functional part, such as an end piece on a ribbed protective hose or the like. Such a two-piece functional part 21 comprising two identical half-shells 22, 22′ is shown in FIGS. 4a and 4b. As shown, the functional part 21 has several stepped areas. Thus, a direct joining together of the two half-shells 22, 22′ would only be possible in a complicated manner, quite apart from the fact that this would lead to the provision of fastening areas, so that the two parts could not be made in the same mould.

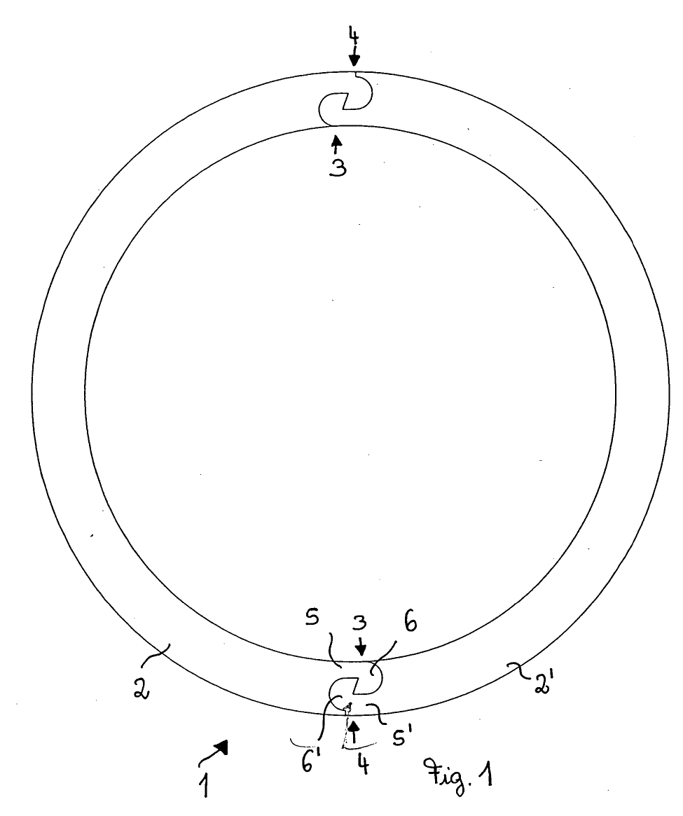

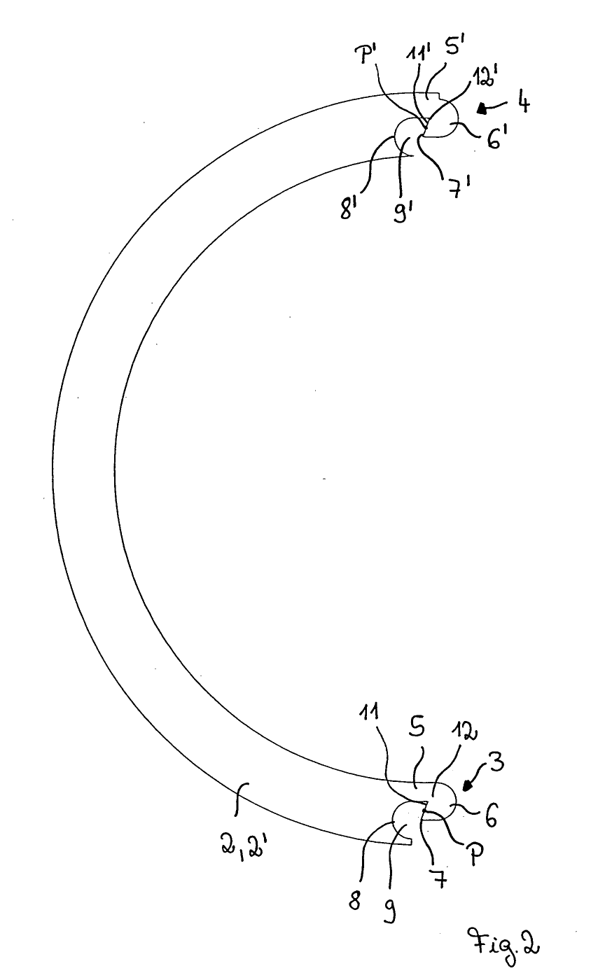

FIG. 4b shows how said functional part 21 can be held together by means of its section 23 (FIG. 4a) through an inventive closing ring 1, as explained relative to FIGS. 1 to 3c. The closing ring 1 is frictionally or non-frictionally located on section 23 of functional part 1, but can additionally frictionally engage on an end wall 24 of an area 25 of functional part 21, but not on the opposite side, because cause from there has to take place the axially parallel sliding of the two partial rings 2, 2′ into each other.

1. Ring part with at least two partial rings to be joined together with joining devices on the front faces of partial rings, wherein the joining devices are non-flexible, positively interlocking shapes.

2. Ring part according to claim 1, wherein the shapes have hooks engaging behind one another.

3. Ring part according to claim 1, wherein the shapes have a substantially point symmetrical construction.

4. Ring part according to claim 1, wherein back-engaging surfaces of shapes are inclined to the radius of the ring part.

5. Ring part according to claim 4, wherein the surfaces inclined to the radius pass from an inner, concave edge, in the vicinity of which the hook is joined to the partial ring, to an outer, free, convex edge on the actual partial ring.

6. Ring part according to claim 1, wherein the shapes are axially frictionally retained.

7. Method for closing a ring part comprising at least two partial rings to be joined together with joining devices on the front faces of partial rings, wherein the partial rings are joined together by the axial sliding of their joining devices constructed as interlocking shapes into each other.
